(19) United States
(12) Patent Application Publication
(10) Pub. No.: US 2009/0278765 A1
(43) Pub. Date: Nov. 12, 2009

(54) IMAGE ADJUSTMENT AND PROCESSING FOR A HEAD UP DISPLAY OF A VEHICLE

(75) Inventor: Steven A. STRINGFELLOW, Oakland, MI (US)

Correspondence Address: INGRASSIA FISHER & LORENZ, P.C. (GM), 7010 E. COCHISE ROAD, SCOTTSDALE, AZ, 85253, US

(73) Assignee: GM GLOBAL TECHNOLOGY OPERATIONS, INC., DETROIT, MI (US)

(21) Appl. No.: 12/118,122

(22) Filed: May 9, 2008

(51) Int. Cl. G09G 5/00

(52) U.S. Cl. 345/7

(57) ABSTRACT

A system and related methods for processing images in a head up display (HUD) system of a vehicle are provided. The images are processed by adjusting the image data in a manner that compensates for different shape and contour characteristics of the windshield of the vehicle. One processing method begins by providing a plurality of image compensation templates, each being applicable to alter display characteristics of image data. During operation of the HUD system the method selects one of the plurality of image compensation templates for use as a compensating template, adjusts original image data in accordance with the compensating template to obtain adjusted image data, and renders the adjusted image data on a HUD display source.

### TECHNICAL FIELD

Embodiments of the subject matter described herein relate generally to head up display (HUD) systems. More particularly, embodiments of the subject matter relate to HUD systems used in vehicles.

### BACKGROUND

A number of vehicles are now available with HUD systems that are designed to project a virtual display of instrumentation data to drivers. For example, HUD systems can be used to generate a virtual speedometer, a virtual tachometer, and/or other virtual instruments for the vehicle. A typical onboard HUD system generates a source image that is reflected using one or more mirrors and, ultimately, the windshield of the vehicle. The driver perceives the image reflected from the windshield. For example, FIG. 1 is a cross sectional schematic view of a prior art HUD system 100 deployed in a vehicle. HUD system 100 includes a HUD display element 102, a fold mirror 104, and a curved magnification mirror 106. These components, are usually located within a cavity 108 of the vehicle dashboard 110.

FIG. 1 illustrates a typical head position 112 for the driver. As depicted in FIG. 1, the image generated at HUD display element 102 is reflected along the path from fold mirror 104, to curved magnification mirror 106, to the windshield 114 of the vehicle, and to the driver. The image is rendered such that it appears near the front of the vehicle, when perceived by the driver. FIG. 1 depicts this focal point 116 near the front bumper of the vehicle. Fold mirror 104 and curved magnification mirror 106 are both in a fixed position. Accordingly, the HUD system 100 requires a relatively large opening 118 in dashboard 110 to accommodate the generation of a relatively wide field of view for the HUD image. The shaded region of FIG. 1 represents this field of view (or “eyebox”). If the driver's line of sight is outside of this field of view, then the HUD image may include vignetting or it may be cropped at one or more of its edges. Moreover, although the HUD image may appear clear and undistorted for some drivers, the image may appear less clear and/or distorted for other drivers. For example, if the optical and imaging characteristics of HUD system 100 are optimized for a driver having an average height, then the quality of the HUD image may be poor for very short or very tall drivers.

### BRIEF SUMMARY

A method for processing images in a HUD system of a vehicle is provided. The method may begin by providing a plurality of image compensation templates, where each template can be applied to alter display characteristics of image data. The method involves selecting one of the plurality of image compensation templates for use as a compensating template, adjusting original image data in accordance with the compensating template to obtain adjusted image data, and rendering the adjusted image data on a HUD display source.

A HUD system for a vehicle having a windshield is also provided. The HUD system includes a HUD display source, a mirror configured to reflect images that originate from the HUD display source, and a motor coupled to the mirror. The motor adjusts the position of the mirror such that the mirror reflects images toward a controlled image target area of the windshield. The motor has related motor position data that is indicative of the position of the mirror. The HUD system also includes an image processor coupled to the HUD display source. The image processor is configured to transform original image data into adjusted image data in a variable manner that is influenced by the motor position data. The HUD display source is configured to render the adjusted image data.

A method for processing images in a HUD system of a vehicle having a windshield is also provided. The method involves selecting a controlled image target area from a plurality of different image target areas of the windshield, selecting, based upon the controlled image target area, one of a plurality of different position-dependent image transformation settings for use as a current transformation setting, and transforming original image data in accordance with the current transformation setting to obtain transformed image data. The method then renders the transformed image data on a HUD display source.

This summary is provided to introduce a selection of concepts in a simplified form that are further described below in the detailed description. This summary is not intended to identify key features or essential features of the claimed subject matter, nor is it intended to be used as an aid in determining the scope of the claimed subject matter.

### BRIEF DESCRIPTION OF THE DRAWINGS

A more complete understanding of the subject matter may be derived by referring to the detailed description and claims when considered in conjunction with the following figures, wherein like reference numbers refer to similar elements throughout the figures.

FIG. 1 is a schematic cross sectional view of a prior art HUD system deployed in a vehicle;

FIG. 2 is a schematic representation of an embodiment of a HUD system suitable for use in a vehicle;

FIGS. 3 and 4 are schematic cross sectional views of an embodiment of a HUD system having adjustable imaging characteristics;

FIG. 5 is a flow chart that illustrates an embodiment of a HUD image adjustment process;

FIG. 6 is a simplified forward-facing view of a windshield, showing different image target areas on the windshield; and

FIG. 7 is a diagram that illustrates the effect of HUD image adjustment for an exemplary embodiment.

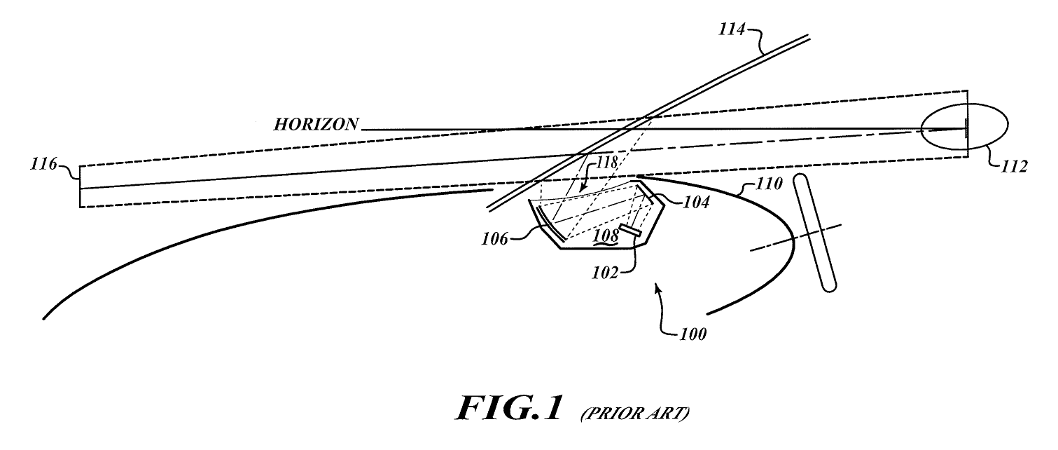

### DETAILED DESCRIPTION

The following detailed description is merely illustrative in nature and is not intended to limit the embodiments of the subject matter or the application and uses of such embodiments. As used herein, the word “exemplary” means “serving as an example, instance, or illustration.” Any implementation described herein as exemplary is not necessarily to be construed as preferred or advantageous over other implementations. Furthermore, there is no intention to be bound by any expressed or implied theory presented in the preceding technical field, background, brief summary or the following detailed description.

Techniques and technologies may be described herein in terms of functional and/or logical block components, and with reference to symbolic representations of operations, processing tasks, and functions that may be performed by various computing components or devices. It should be appreciated that the various block components shown in the figures may be realized by any number of hardware, software, and/or firmware components configured to perform the specified functions. For example, an embodiment of a system or a component may employ various integrated circuit components, e.g., memory elements, digital signal processing elements, logic elements, look-up tables, or the like, which may carry out a variety of functions under the control of one or more microprocessors or other control devices.

For the sake of brevity, conventional techniques related to HUD systems, digital image processing, computer graphics, and other functional aspects of the systems (and the individual operating components of the systems) may not be described in detail herein. Furthermore, the connecting lines shown in the various figures contained herein are intended to represent exemplary functional relationships and/or physical couplings between the various elements. It should be noted that many alternative or additional functional relationships or physical connections may be present in an embodiment of the subject matter.

An onboard HUD system for a vehicle is described herein. Such a HUD system utilizes optics and image processing to compensate for distortion effects introduced by a given windshield shape. A mirror in the HUD system is adjusted to move the HUD image to accommodate the particular eye position of the driver. Movement of the HUD image results in a change in the image target area of the windshield from which the HUD image is reflected. The shape of most vehicle windshields varies throughout the HUD image adjustment range and, consequently, the shape of the reflected HUD image may distort when the image target area is moved. This creates an effect akin to a funhouse mirror, where the image perceived by the user appears altered, bent, distorted, or deformed.

The HUD system described herein adjusts its optics and image processing according to user-initiated instructions that control the position of the HUD image. The image target area of the windshield is correlated to the electronic adjustment of the HUD system mirror (or mirrors). The corresponding distortion pattern for each particular image target area of the windshield is utilized to pre-distort or compensate the HUD image in an appropriate manner. Thus, the original image rendered on the HUD display source is pre-warped in anticipation of the distortion to be introduced by the given image target area of the windshield. As a result, the actual HUD image as viewed by the driver will appear clear, crisp, and undistorted.

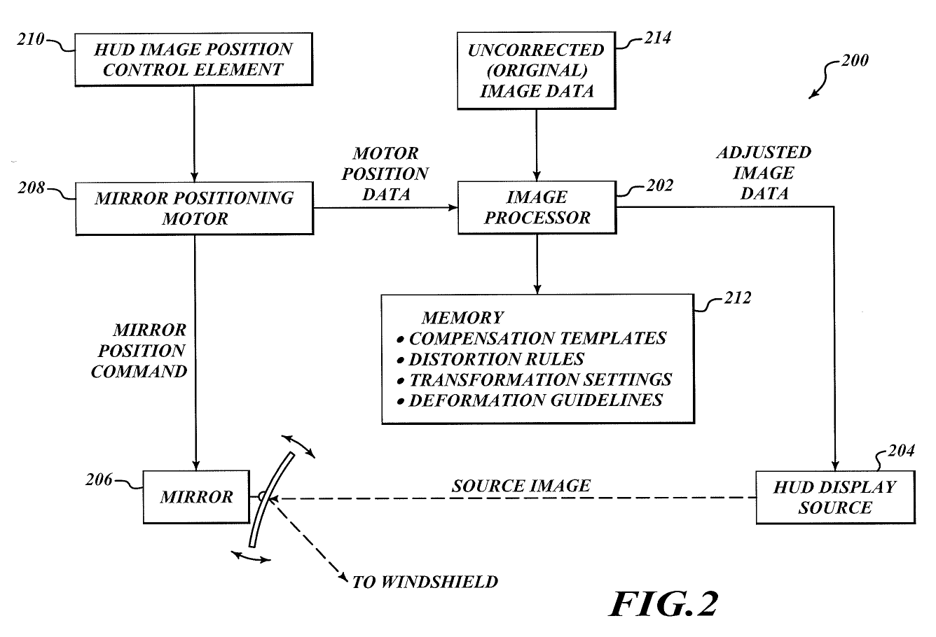

FIG. 2 is a schematic representation of an embodiment of a HUD system 200 suitable for use in a vehicle. HUD system 200 is suitably configured to operate as briefly described above. HUD system 200 generally includes, without limitation: an image processor 202; a HUD display source 204; an adjustable mirror 206; a motor 208 for adjusting the position of adjustable mirror 206; a HUD image position control element 210; and an appropriate amount of memory 212, which may be realized as one or more distinct memory elements and/or incorporated into image processor 202 itself. These, and possibly other elements and components, may be coupled together using any suitable wired and/or wireless interconnection arrangement or architecture to accommodate the transfer of data, information, control signals, and/or commands as needed to support the operation of HUD system 200. In an onboard deployment, image processor 202, HUD display source 204, and memory 212 may be packaged together as a single circuit module, and all of the elements depicted in FIG. 2 may be located within a cavity or enclosure formed in the dashboard of the vehicle (with the possible exception of HUD image position control element 210, which may be located in the passenger compartment such that it is accessible to the driver).

Image processor 202 may be implemented or performed with a general purpose processor, a content addressable memory, a digital signal processor, an application specific integrated circuit, a field programmable gate array, any suitable programmable logic device, discrete gate or transistor logic, discrete hardware components, or any combination designed to perform the functions described here. A processor may be realized as a microprocessor, a controller, a microcontroller, or a state machine. Moreover, a processor may be implemented as a combination of computing devices, e.g., a combination of a digital signal processor and a microprocessor, a plurality of microprocessors, one or more microprocessors in conjunction with a digital signal processor core, or any other such configuration.

Memory 212 is utilized as a memory element for image processor 202. Memory 212 may be realized as RAM memory, flash memory, EPROM memory, EEPROM memory, registers, a hard disk, a removable disk, a CDROM, or any other form of storage medium known in the art. In this regard, memory 212 can be coupled to image processor 202 such that image processor 202 can read information from, and write information to, memory 212. In the alternative, memory 212 may be integral to image processor 202. As an example, image processor 202 and memory 212 may reside in an ASIC. As described in more detail below, memory 212 can be utilized to store and maintain data associated with, or representative of, different image processing schemes, including, without limitation: image compensation templates; image distortion rules; image transformation settings; image deformation guidelines; image adjustment algorithms; or the like.

Image processor 202 is suitably configured to perform the various routines, tasks, processes, and functions that support the operation of HUD system 200 as described in more detail herein. For example, image processor 202 is preferably configured to transform original (i.e., uncorrected) image data 214 into adjusted image data in a variable manner that is influenced by one or more adjustable characteristics or parameters of HUD system 200. These adjustable characteristics or parameters may include, without limitation: position data associated with a position of motor 208; mirror position commands that control the positioning of adjustable mirror 206; a windshield image target area utilized for the HUD image; a user-initiated request to control the position of adjustable mirror 206; seat position data associated with the adjustment of the driver's seat; and the like. As depicted in FIG. 2, image processor 202 presents the adjusted image data to HUD display source 204 for rendering as a source image.

HUD display source 204 is suitably configured render and display source images that are reflected for use as the actual HUD images. In this regard, HUD display source 204 can generate source images having any appropriate content, including, without limitation: the vehicle speed; vehicle warning indicators; cruise control status information; and/or clock information. In practice, image processor 202 may include or cooperate with an appropriate display driver (not shown), which controls and manages the rendering of graphical information on HUD display source 204. Notably, the specific configuration, operating characteristics, size, resolution, and functionality of HUD display source 204 can vary depending upon the practical implementation of HUD system 200. For example, HUD display source 204 may be realized using LCD, plasma display, LED, OLED, or other display technologies. In preferred embodiments, HUD display source 204 is of relatively high quality and high resolution, which is desirable to facilitate the various image processing techniques described here. In practice, HUD display source 204 may have a horizontal resolution within the range of about 300-800 pixels, and a vertical resolution within the range of about 150-600 pixels. In accordance with one embodiment that utilizes 5× magnification, HUD display source 204 has a resolution of 480 (horizontal) by 240 (vertical) pixels. In accordance with another embodiment that utilizes 7× magnification, HUD display source 204 has a 3:1 widescreen format that employs a resolution of 640 (horizontal) by 212 (vertical) pixels.

The dashed line in FIG. 2 illustrates how adjustable mirror 206 reflects images that originate from HUD display source 204. Certain embodiments of HUD system 200 include one or more fold mirrors (not shown in FIG. 2) between HUD display source 204 and adjustable mirror 206. Adjustable mirror 206 is preferably realized as a curved aspheric magnifying mirror that magnifies the incident image. In practice, the magnification factor of adjustable mirror 206 may be within the range of about 3× to 7×. Adjustable mirror 206 is configured, aligned, and positioned to reflect its incident image toward the windshield of the vehicle. Notably, adjustable mirror 206 is electronically controllable to rotate about at least one axis. For the particular embodiment schematically depicted in FIG. 2, adjustable mirror 206 can rotate about an axis that extends perpendicularly into and out of the page.

As mentioned above, HUD system 200 can electronically control the rotatable position of adjustable mirror 206. In this regard, HUD system 200 includes motor 208, which is coupled to adjustable mirror 206 such that motor 208 can rotate adjustable mirror 206 as needed. Accordingly, motor 208 adjusts the position of adjustable mirror 206 such that adjustable mirror 206 reflects images toward a controlled image target area of the windshield (as described in more detail below). In other words, rotation of adjustable mirror 206 results in a corresponding shift in the image target area at which the reflected image is directed. In certain embodiments, motor 208 is realized as an electronic stepper motor that rotates adjustable mirror 206 in a stepwise manner. Thus, a given position or state of motor 208 corresponds to a respective position or state of adjustable mirror 206. In this regard, motor 208 may generate or include associated motor position data that is indicative of the position of adjustable mirror 206. Moreover, motor 208 may generate or include an associated mirror position command that controls the position of adjustable mirror 206 relative to the windshield. Depending upon the particular embodiment of HUD system 200, image processor 202 may process the motor position data and/or the mirror position command to determine how best to generate the adjusted image data.

This embodiment of HUD system 200 uses HUD image position control element 210 to initiate adjustment of the HUD image as perceived by the driver. HUD image position control element 210 may be realized as one or more switches, one or more buttons, one or more knobs, and/or any suitable user interface element that is configured to obtain user-initiated commands or requests. In practice, HUD image position control element 210 may employ physical devices, software driven display menus, a touch screen, a touchpad, a voice-activated control element, or the like. In preferred embodiments, HUD image position control element 210 is manipulated, engaged, or otherwise activated to control the position of motor 208, which in turn controls the position of adjustable mirror 206, which in turn controls the image target area on the windshield.

Image processor 202 applies the different image compensation templates, rules, settings, guidelines, and/or protocols to adjust the original image data 214 as needed such that the resulting HUD image as perceived by the driver is relatively distortion free, clear, and crisp, with little or no cropping, vignetting, or other unwanted visual artifacts. To accomplish this, image processor 202 applies a position-dependent image adjustment scheme to original image data 214, where the given image adjustment scheme corresponds to the current position of adjustable mirror 206 and, in turn, the current image target area on the windshield. For example, more image compensation is applied when the image target area corresponds to a highly contoured section of the windshield, and less image compensation is applied when the image target area corresponds to a less contoured section of the windshield.

In the preferred embodiment, HUD system 200 utilizes a plurality of predetermined image adjustment schemes, where the set of schemes is calibrated for the particular size, shape, and contour of the windshield. Accordingly, a different set of image compensation schemes can be utilized for each model of vehicle (assuming that each model uses the same production windshield). The calibration procedure for a given windshield may contemplate and identify different possible image target areas on the windshield, and then analyze the shape, contour, and optical characteristics of the image target areas. Then, for each image target area, the reflective properties are determined such that any distortion or deformation pattern can be identified and quantified. Thereafter, a corresponding image compensation template, algorithm, or rule is created for each image target area, where an image compensation template, algorithm, or rule represents the inverse of the distortion/deformation characteristic of the respective image target area. In other words, an image compensation rule results in pre-distortion or pre-deformation of original image data 214 in a manner that depends upon the respective image target area and, consequently, the respective position of adjustable mirror 206.

As mentioned previously, HUD system 200 may carry out image adjustment schemes using different techniques. For example, an image adjustment scheme may be realized using templates, rules, settings, algorithms, guidelines, protocols, or routines to perform image compensation, image distortion, or image transformation. Notably, each image adjustment scheme is applicable to alter the display characteristics of original image data 214. HUD system 200 may leverage any suitable image processing techniques and technologies to implement its image adjustment schemes. In this regard, HUD system 200 may utilize existing, known, or conventional image processing techniques and routines.

An “image compensation template” refers to a conceptual processing overlay that defines how the graphical elements of original image data 214 will be altered within the area of HUD display source 204. Conceptually, an image compensation template is akin to a distorting lens or filter that, when placed over original image data 214, results in the desired adjusted image data. As used herein, an “image distortion rule” is a rule (or set of rules) that governs how original image data 214 is modified to create the adjusted image data. Alternatively or additionally, HUD system 200 might utilize different image transformation settings, where an “image transformation setting” represents one or more configurable parameters, variables, options, or characteristics that influence the manner in which image processor 202 alters original image data 214 into the respective adjusted image data. For example, an image transformation setting may dictate parameters such as, without limitation: stretching, bending, rotation, shrinking, translation, swirling, or the like.

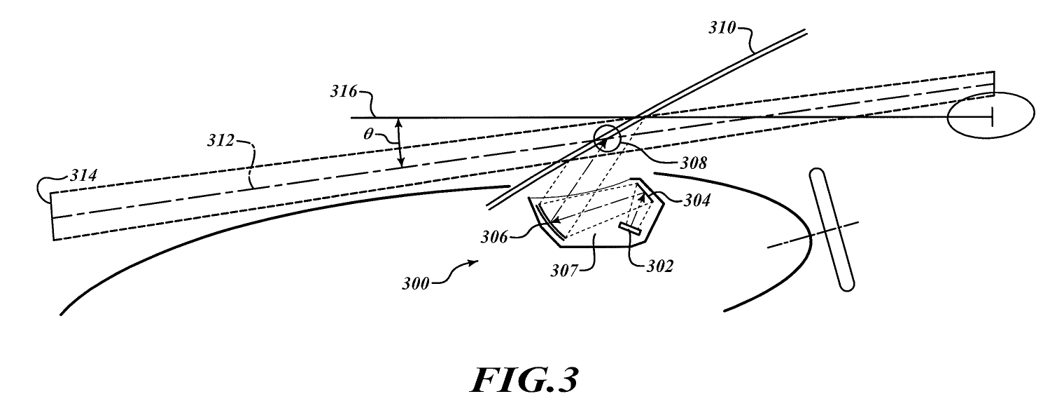

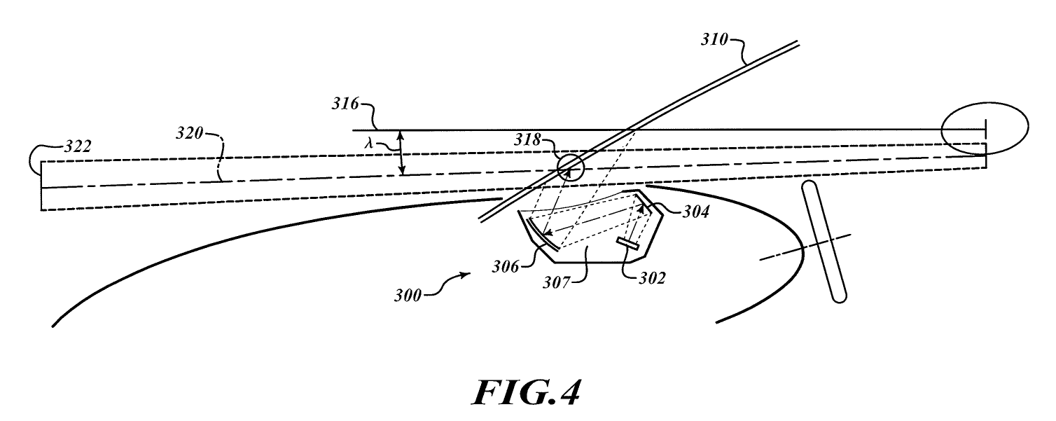

FIGS. 3 and 4 are schematic cross sectional views of an embodiment of a HUD system 300 having adjustable imaging characteristics. FIG. 3 depicts HUD system 300 in a state that accommodates a relatively tall driver, and FIG. 4 depicts HUD system 300 in a state that accommodates a relatively short driver. HUD system 300 may be generally configured as described above for HUD system 200, and the individual elements of HUD system 300 function in the same manner as their counterpart elements of HUD system 200. Accordingly, such common and shared features, functions, and operations will not be redundantly described in detail here for HUD system 300.

Referring to FIG. 3, HUD system 300 generally includes, without limitation: a HUD display source 302; a fold mirror 304; and an adjustable mirror 306. Although not always required, HUD display source 302 and fold mirror 304 are nonadjustable, and their positions are stationary. These and possibly other components of HUD system 300 reside in a cavity or enclosure 307 of the host vehicle. The source image rendered on HUD display source 302 is reflected by fold mirror 304 and, in turn, by adjustable mirror 306. Adjustable mirror 306 is controlled into a position such that its incident image is reflected toward a specific target image area 308 of the windshield 310. Notably, this target image area 308 corresponds to the point of reflection of windshield 310 that best aligns with the viewing (eye) position of the tall driver.

In FIG. 3, the dashed line represents the nominal line of sight 312 from the driver's eyes, through target image area 308, and to the focal point 314 of the resulting HUD image. Notably, this line of sight 312 forms an angle θ with the approximate horizon line 316. The shaded region of FIG. 3 represents the eyebox corresponding for this particular state of HUD system 300. Notably, this eyebox can be relatively narrow due to the highly customized and adjustable nature of HUD system 300. In other words, since adjustable mirror 306 and the resulting target image area 308 are adjusted to suit the viewing requirements of the particular driver (e.g., a relatively tall driver for FIG. 3), the eyebox need not accommodate different viewing angles and sight lines.

In contrast, FIG. 4 depicts HUD system 300 after it has been adjusted to accommodate a relatively short driver. The position of adjustable mirror 306 has been rotated (about an axis of rotation that is perpendicular to the page) such that adjustable mirror 306 is tilted upward relative to its position depicted in FIG. 3. This tilting of adjustable mirror 306 is controlled such that the incident image is reflected toward a different target image area 318 of the windshield 310. This new target image area 318 is lower on windshield 310, relative to target image area 308 (see FIG. 3). Notably, target image area 318 corresponds to the point of reflection of windshield 310 that best aligns with the viewing (eye) position of the short driver.

In FIG. 4, the dashed line represents the nominal line of sight 320 from the driver's eyes, through target image area 318, and to the focal point 322 of the resulting HUD image. Notably, this line of sight 320 forms an angle λ with the approximate horizon line 316. Due to the adjusted line of sight 320, the angle λ is noticeably lower than the corresponding angle θ shown in FIG. 3. As mentioned above, since adjustable mirror 306 and the resulting target image area 318 are adjusted to suit the viewing requirements of the particular driver (e.g., a relatively short driver for FIG. 4), the eyebox need not accommodate different viewing angles and sight lines.

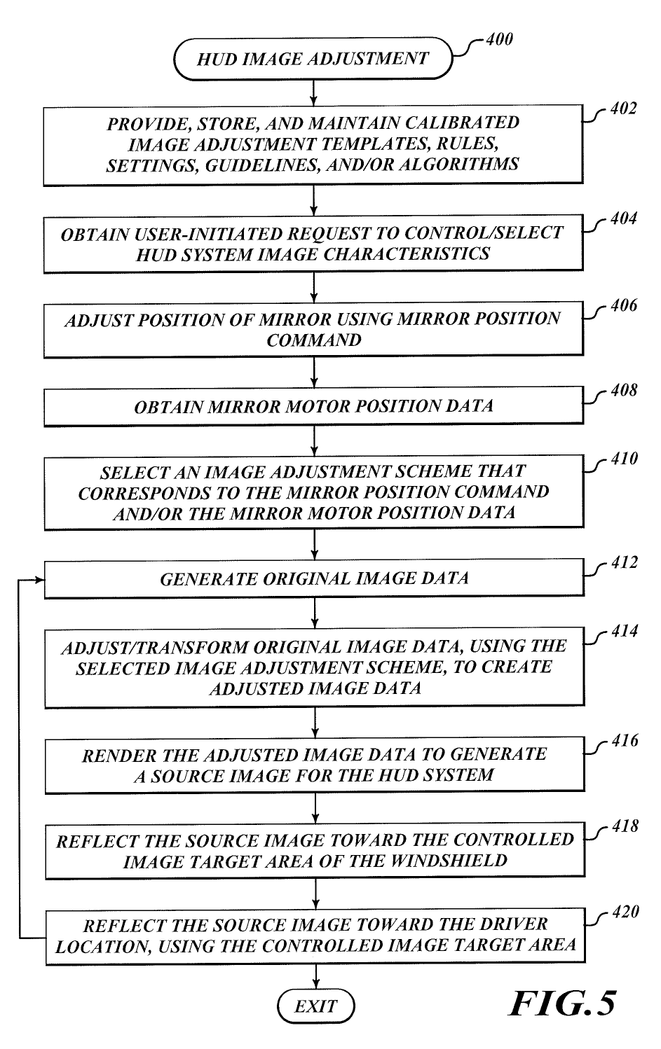

A HUD system as described herein can be suitably configured to produce clear and undistorted HUD images, regardless of the HUD image position setting. In this regard, FIG. 5 is a flow chart that illustrates an embodiment of a HUD image adjustment process 400, which may be carried out by an embodiment of a HUD system, such as those described above. The various tasks performed in connection with process 400 may be performed by software, hardware, firmware, or any combination thereof. For illustrative purposes, the following description of process 400 may refer to elements mentioned above in connection with FIGS. 2-4. In practice, portions of process 400 may be performed by different elements of the described system, e.g., the image processor, the HUD display source, or the mirror positioning motor. It should be appreciated that process 400 may include any number of additional or alternative tasks, the tasks shown in FIG. 5 need not be performed in the illustrated order, and process 400 may be incorporated into a more comprehensive procedure or process having additional functionality not described in detail herein.

HUD image adjustment process 400 may begin with (or be initialized by) providing, storing, and maintaining a plurality of calibrated image processing schemes for the HUD system (task 402). Depending upon the particular embodiment, task 402 may be associated with different image adjustment templates, rules, settings, algorithms, guidelines, protocols, or the like, as mentioned above with reference to FIG. 2. For example, process 400 may utilize a plurality of image compensation templates, a plurality of image distortion rules, a plurality of image transformation settings, or the like.

During operation of the vehicle, process 400 may obtain a user-initiated request to control and/or select certain HUD system image characteristics (task 404). For example, the user-initiated request may be: a command to adjust the height of the HUD image; a request to control the position of an adjustable mirror of the HUD system; a request to control the position of the motor used to adjust the mirror; a mirror position command; a request to select a controlled image target area from a plurality of different image target areas of the windshield; or the like. For this exemplary embodiment, task 404 is performed when the driver engages a user interface element that controls the displayed position of the HUD image. In turn, this causes the mirror positioning motor to adjust the position (tilt) of the adjustable mirror, using an appropriate mirror position command (task 406). In addition, this causes the image processor to obtain motor position data (task 408) from the motor.

Process 400 may then utilize the mirror position command and/or the motor position data to influence or determine its selection of a particular image adjustment scheme that best matches the current height of the HUD image (task 410). For example, if the HUD image is relatively high on the windshield, then task 410 may select image compensation template A. On the other hand, if the HUD image is relatively low on the windshield, then task 410 may select image compensation template B. Again, task 410 may select a designated image compensation template, a designated image distortion rule, or a designated image transformation setting, and the selection performed during task 410 may be governed by the mirror position command, the motor position data, and/or the particular image target area that corresponds to the user-controlled HUD image height.

During operation, the HUD system generates the original image data (task 412), which represents the intended HUD display content. As explained above, this original image data need not actually be rendered or displayed. Rather, process 400 adjusts, transforms, pre-corrects, distorts, alters, or otherwise modifies the original image data (task 414), in accordance with the image adjustment scheme selected during task 410. The data processing that occurs during task 414 results in adjusted, transformed, altered, or modified image data that is derived from the original image data. The adjusted image data is generated in a suitable manner that compensates for the curvature of the windshield at the controlled image target area (which, in turn, is dependent upon the adjusted height of the HUD display).

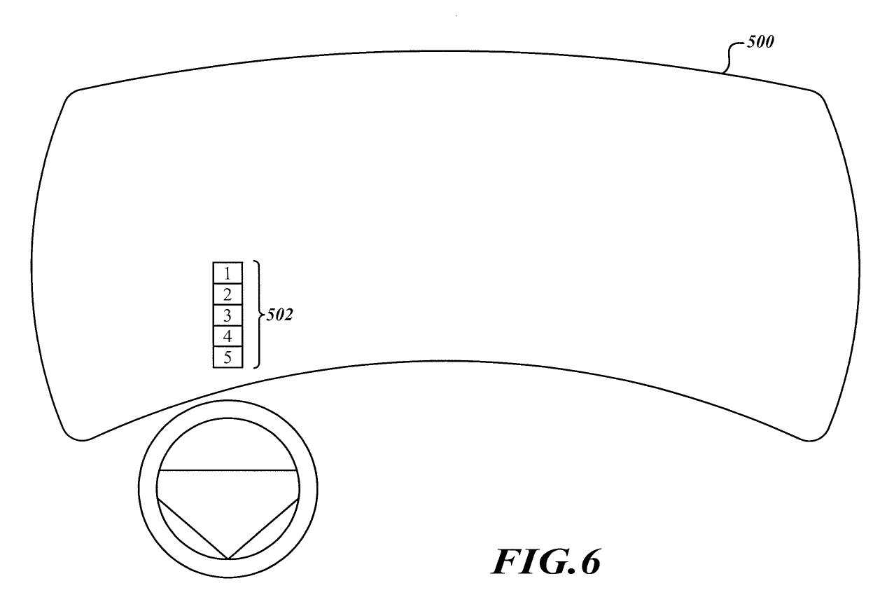

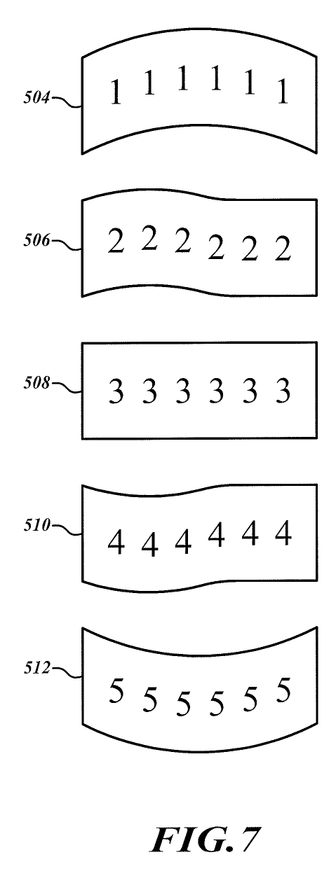

In an exemplary embodiment, the adjusted image data is formatted such that the HUD display source can render it in an appropriate manner in accordance with its native capabilities, settings, and configuration. Accordingly, process 400 renders the adjusted image data on the HUD display source to generate a corresponding source image for the HUD system (task 416). The actual source image displayed at the HUD display source will appear distorted, warped, bent, or misshapen in most circumstances, and the particular distortion characteristics of the source image will depend upon the specific image target area. In this regard, FIG. 6 is a simplified forward-facing view of a windshield 500, showing different image target areas 502 on the windshield 500, and FIG. 7 is a diagram that illustrates an exemplary effect of HUD image adjustment for image target areas 502. FIG. 6 represents a view of windshield 500 from inside the passenger compartment of the vehicle.

The embodiment depicted in FIG. 6 supports five different image target areas 502, labeled one to five. The size, shape, location, and number of image target areas 502 can vary from one implementation of the HUD system to another, and the use of five image target areas 502 in a vertical alignment as shown does not limit or restrict the application or scope of the embodiments described herein. As explained previously, each image target area 502 might have a different pre-computed and preloaded image adjustment scheme associated therewith. When the HUD system is set to the first image target area (labeled number one), the source image rendered on the HUD display source may have a relatively high amount of deformation that corresponds with a relatively high curvature/contour of windshield 500 at the first image target area. Referring to the exemplary diagram of FIG. 7, a source image 504 corresponding to the first image target area has a relatively high amount of upward curvature and distortion. In contrast, a source image 506 for the second image target area has less curvature and distortion. Notably, a source image 508 associated with the third image target area has little to no perceivable distortion or deformation. In certain embodiments, such undistorted source images may be generated to accommodate image target areas that are relatively flat. For this particular embodiment, a source image 510 for the fourth image target area has an intermediate amount of image curvature and deformation, and a source image 512 for the fifth image target area has a relatively high amount of distortion and curvature, which indicates that the fifth image target area has a relatively high amount of curvature and contour.

Referring again to FIG. 5, HUD image adjustment process 400 reflects the source image toward the selected image target area (task 418), using at least one adjustable mirror, such as an aspheric magnifying mirror. As mentioned above, task 418 may also utilize one or more flat fold mirrors to reflect the source image from the HUD display source along the desired path. Thereafter, the source image is further reflected toward the driver location, using the windshield as a reflector (task 420). In particular, the selected image target area of the windshield serves as the final reflector of the source image. As the source image is reflected from the windshield, the selected image target area will alter the shape, size, contour, and possibly other characteristics of the incident image in the manner anticipated by the chosen image adjustment scheme. Consequently, the HUD image that is actually perceived by the driver will be relatively distortion free, and with the desired shape and clarity. In other words, in preferred implementations, the driver will not experience any unwanted image cropping, vignetting, deformation, bending, or distortion.

After task 420, process 400 may exit or it may be re-entered at task 412 as needed to update the HUD system with new original image data. In other words, tasks 412, 414, 416, 418, and 420 can be repeated to continuously or periodically update the HUD image as long as the position of the HUD image remains unchanged. If, however, the position of the HUD image is adjusted (with a corresponding adjustment of the controlled image target area on the windshield), then process 400 may be repeated or re-entered at an appropriate point, e.g., at task 404 or task 406.

While at least one exemplary embodiment has been presented in the foregoing detailed description, it should be appreciated that a vast number of variations exist. It should also be appreciated that the exemplary embodiment or embodiments described herein are not intended to limit the scope, applicability, or configuration of the claimed subject matter in any way. Rather, the foregoing detailed description will provide those skilled in the art with a convenient road map for implementing the described embodiment or embodiments. It should be understood that various changes can be made in the function and arrangement of elements without departing from the scope defined by the claims, which includes known equivalents and foreseeable equivalents at the time of filing this patent application.

What is claimed is:

1. A method for processing images in a head up display (HUD) system of a vehicle, the method comprising:
providing a plurality of image compensation templates, each of the image compensation templates being applicable to alter display characteristics of image data;
selecting one of the plurality of image compensation templates for use as a compensating template;
adjusting original image data in accordance with the compensating template to obtain adjusted image data; and
rendering the adjusted image data on a HUD display source.

2. The method of claim 1, wherein:
the vehicle comprises a windshield;
the HUD system comprises a mirror configured to reflect images, which originate from the HUD display source, toward the windshield;
the method further comprises obtaining a mirror position command that controls a position of the mirror relative to the windshield; and
selecting one of the plurality of image compensation templates is influenced by the mirror position command.

3. The method of claim 1, wherein:
the vehicle comprises a windshield;
the HUD system comprises a mirror configured to reflect images, which originate from the HUD display source, onto the windshield, and further comprises a motor configured to move the mirror;
the method further comprises obtaining motor position data that indicates a position of the motor; and
selecting one of the plurality of image compensation templates is influenced by the motor position data.

4. The method of claim 1, wherein:
the vehicle comprises a windshield;
rendering the adjusted image data results in a source image at the HUD display source; and
the method further comprises reflecting the source image toward a controlled image target area of the windshield.

5. The method of claim 4, wherein:
the controlled image target area is one of a plurality of selectable image target areas of the windshield; and
selecting one of the plurality of image compensation templates is influenced by the controlled image target area.

6. The method of claim 4, wherein adjusting original image data comprises distorting the original image data to compensate for curvature of the windshield at the controlled image target area.

7. A head up display (HUD) system for a vehicle having a windshield, the HUD system comprising:
a HUD display source;
a mirror configured to reflect images that originate from the HUD display source;
a motor coupled to the mirror, the motor being configured to adjust a position of the mirror such that the mirror reflects images toward a controlled image target area of the windshield, and the motor having associated motor position data that is indicative of the position of the mirror; and
an image processor coupled to the HUD display source, the image processor being configured to transform original image data into adjusted image data in a variable manner that is influenced by the motor position data, wherein the HUD display source is configured to render the adjusted image data.

8. The HUD system of claim 7, wherein the mirror is an aspheric magnifying mirror.

9. The HUD system of claim 7, wherein:
the image processor is configured to select one of a plurality of image distortion rules for use as a distorting rule; and
the image processor transforms the original image data into the adjusted image data in accordance with the distorting rule.

10. The HUD system of claim 9, wherein the image processor selects one of the plurality of image distortion rules in accordance with the motor position data.

11. The HUD system of claim 9, further comprising a memory element for the image processor, the memory element being configured to store the plurality of image distortion rules.

12. The HUD system of claim 9, wherein:
each of the plurality of image distortion rules corresponds to a different selectable image target area of the windshield; and
when applied to image data, each of the plurality of image distortion rules compensates for curvature of the windshield at a respective image target area.

13. The HUD system of claim 7, further comprising a HUD image position control element configured to obtain user-initiated requests that control the position of the mirror.

14. A method for processing images in a head up display (HUD) system of a vehicle having a windshield, the method comprising:
selecting a controlled image target area from a plurality of different image target areas of the windshield;
selecting, based upon the controlled image target area, one of a plurality of different position-dependent image transformation settings for use as a current transformation setting;
transforming original image data in accordance with the current transformation setting to obtain transformed image data; and
rendering the transformed image data on a HUD display source.

15. The method of claim 14, wherein:
rendering the transformed image data results in a source image at the HUD display source; and
the method further comprises reflecting the source image toward the controlled image target area.

16. The method of claim 14, wherein:
the HUD system comprises a mirror configured to reflect images, which originate from the HUD display source, toward the windshield;
selecting a controlled image target area comprises obtaining a mirror position command that controls a position of the mirror relative to the windshield; and
selecting one of the plurality of different position-dependent image transformation settings is influenced by the mirror position command.

17. The method of claim 16, further comprising obtaining a user-initiated request to control the position of the mirror, wherein the mirror position command corresponds to the user-initiated request.

18. The method of claim 14, wherein:
the HUD system comprises a mirror configured to reflect images, which originate from the HUD display source, toward the windshield, and further comprises a motor configured to move the mirror;
selecting a controlled image target area comprises obtaining motor position data that indicates a position of the motor; and
selecting one of the plurality of different position-dependent image transformation settings is influenced by the motor position data.

19. The method of claim 18, further comprising obtaining a user-initiated request to control the position of the motor, wherein the motor position data corresponds to the user-initiated request.

20. The method of claim 14, wherein transforming original image data comprises altering the original image data to compensate for curvature of the windshield at the controlled image target area.
